(19) United States
(12) Patent Application Publication
(10) Pub. No.: US 2010/0006164 A1
(43) Pub. Date: Jan. 14, 2010

(54) Bathtub diverter spout with ball valve

(76) Inventors: Luis A. Moncayo, Santa Ana, CA (US); Paul G. Torrealba, Santa Ana, CA (US)

Correspondence Address: GORDON K ANDERSON, 14632 PACIFIC STREET, TUSTIN, CA, 92780, US

(21) Appl. No.: 12/286,272

(22) Filed: Sep. 30, 2008

Related U.S. Application Data
(60) Provisional application No. 61/134,769, filed on Jul. 14, 2008.

(51) Int. Cl. F16K 11/00

(52) U.S. Cl. 137/625

(57) ABSTRACT

A bathtub diverter spout (10) for in-the-wall showers is taught, with the spout having a manual shut-off valve in the form of a ball valve (30). The diverter spout consists of a spout body (20) having a round open end tapering to a rectangular downward extending spout discharge opening (24) with a top surface (26) in-between. A vertical bulkhead (28), with a round hole therein, is disposed within the body adjacent to the discharge opening. The ball valve extends through the hole in the bulkhead and is fastened with a hermetic seal. The ball valve includes a valve stem (40) that extends vertically through the spout body top surface, and a handle (52) is attached on top of the valve stem. The valve diverts water to a shower head when the valve ball is rotated parallel with the spout and returns the water to a bathtub when the valve is rotated to a spout transverse position.

### CROSS REFERENCE TO RELATED APPLICATION

This application claims priority of Provisional Patent Application Ser. No. 61/134,769 filed Jul. 14, 2008.

### TECHNICAL FIELD

The present invention relates to diverter spouts for bathtubs in general. More specifically to a diverter spout utilizing a ball valve for diverting water to the shower head to provide positive shutoff and reliability.

### BACKGROUND ART

Previously, many types of bathtub diverter spouts have been used in endeavoring to provide an effective means to permit a shower head to receive the flow of water bypassing the bathtub filler spout by pulling up a lever located in the top portion of the spout.

The prior art listed below did not disclose patents that possess any of the novelty of the instant invention; however the following U.S. patents are considered related:

| Pat. No. | Inventor | Issue Date |
|---|---|---|
| 3,416,555 | Chapou | Dec. 17, 1968 |
| 3,656,503 | Ward | Apr. 18, 1972 |
| 3,801,997 | Ward | Apr. 09, 1974 |
| Des.245,507 | Crow | Aug. 23, 1977 |
| 4,393,523 | Nolden | Jul. 19, 1983 |
| 4,997,007 | Niemann et al. | Mar. 05, 1991 |
| 6,718,569 B2 | Burger et al. | Apr. 13, 2004 |
| 6,880,565B2 | Ouyoung | Apr. 19, 2005 |

Chapou in U.S. Pat. No. 3,416,555 teaches a reversing cock for distributing water under pressure using a nozzle with an outlet orifice and a union adapted to be connected to a shower pipe. The water is controlled by a conventional valve in the outlet orifice which is held in the open position spaced with a spring permitting a closed position held by the water pressure distributing water to either a shower nozzle or a bathtub.

U.S. Pat. No. 3,656,503 issued to Ward is for a diverter valve which has an outlet chamber communicating with a water supply. A seat within the chamber has a central aperture through which water flows to a tub when the valve is open. The water flow is interrupted by lifting the valve to restrict the mouth of a cup against the seat with water pressure holding the valve in place.

Ward in U.S. Pat. No. 3,801,997 also discloses a spool valve used conjunction with diverter spouts and shower heads. A spool valve operates between two positions with manual movement of the spool causing a first position maintained with water pressure. When water pressure is terminated the valve assumes a second position under the force of gravity. The valve is in a replaceable cartridge and is used with a self-opening shower head with valve movement in the first position causing a normal spray and in the second position for draining.

Nolden in U.S. Pat. No. 4,393,523 teaches a tub filling and shower fitting having a change-over valve operatively coupled to a tub spout inlet. The change-over valve is shifted from a tub mode to a shower mode by swiveling the tub inlet spout.

U.S. Pat. No. 4,997,007 issued to Niemann et al. consists of a diverter valve assembly having a machined housing seats and a diverter valve having a stem with an inlet and outlet. The outlet is tubular and has an arcuate sealing pad secured by axial flanges and keys on the outlet section. The sealing pad is flexible and the tubular outlet is resiliently flexible to allow an interference fit in a cylindrical bore in the housing.

Burger et al. in U.S. Pat. No. 6,718,569 B2 discloses a tub and shower valve including a valve having a housing with an outwardly opening cup-like socket. A removable cartridge with an outwardly extending stem is installed in a cup-like socket. A plaster ground is provided for mounting and an escutcheon is positioned over the valve housing. A transparent overlay is applied to the cup-like socket with operating instructions.

U.S. Pat. No. 6,880,565B2 of Ouyoung is for a shower bathtub valve assembly using a ceramic cartridge consisting of a valve body and a cylindrical balance valve seat accommodating a balance valve in a central trough. The balance valve is connected to the cartridge and secured in position with a sleeve and a fixation nut.

For background purposes and as indicative of the art to which the invention is related reference may be made to the remaining cited design patent Des.245,507 issued to Crow.

### DISCLOSURE OF THE INVENTION

Conventional spouts for in-the-wall showers normally include a gate valve with a lifting pull-out rod having a knob on top to divert the water to the shower head when the valve is manually held closed until water pressure seals the valve. The spout returns the water to the tub when the valve is depressed breaking the seal of the gate valve.

This type of spout is almost universally accepted throughout the world and usually functions as designed however it has one rather serious drawback in that it has a rather short operational life. The gate valve is purposely rather loose permitting the gate to easily slide up and down in its tracks as the water pressure draws the gate into the seat during operation. In time the gate does not seat properly or the seat leaks not allowing the water to flow to the shower head. While the actual spout is not particularly expensive to replace, the labor to come to the residence and perform the plumbing service combined with the cost of the part may be considerable.

It is therefore the primary object of the invention to create a bathtub diverter spout that increases operational life significantly by the use of a ball valve that has extended life expectancy since it has been proven in the field for decades.

An important object of the invention is that the valve is leak tight which achieves positive control with no dripping at all.

Still another object of the invention is that the flow to the shower head is instant as the water to the tub is shut-off at the exact time the valve is manually closed. Further the shut-off is easily accomplished by simply turning the valve 90 degrees with a twist of the fingers and there is no wait for the pressure to build up.

Yet another object of the invention is that the valve made of materials compatible with tap water and has been designed for customary water pressures and mineral build up common to city water.

A further object of the invention is in the fact that the ball valve maintains full flow without restrictions or pressure differential when filling the bathtub during normal operation.

A final object of the invention is that the diverter spout fits conventional ½ and ¾ inch iron pipe size pipe (IPS) nipples extending 4½ inches to 5.0 inches from the wall. A reducer bushing may be supplied for the ¾ inch size for convenience.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is a partial isometric view of the bathtub diverter spout with a ball valve in the preferred embodiment.

FIG. 2 is a cross sectional view taken along an imaginary center line of FIG. 1.

FIG. 3 is a top plan view of the diverter spout with the handle of the ball valve shown rotated to a closed position in dotted lines.

FIG. 4 is a top elevation plan view of the diverter spout in the preferred embodiment.

FIG. 5 is a front elevation view of the diverter spout in the preferred embodiment.

FIG. 6 is an open end elevation view of the diverter spout in the preferred embodiment.

FIG. 7 is a cutaway bottom elevation plan view of the diverter spout in the preferred embodiment with the plumbing pipe nipple illustrated in dashed lines and the length of the protruding pipe shown with the alpha letter “L” signifying the preferred length.

### BEST MODE FOR CARRYING OUT THE INVENTION

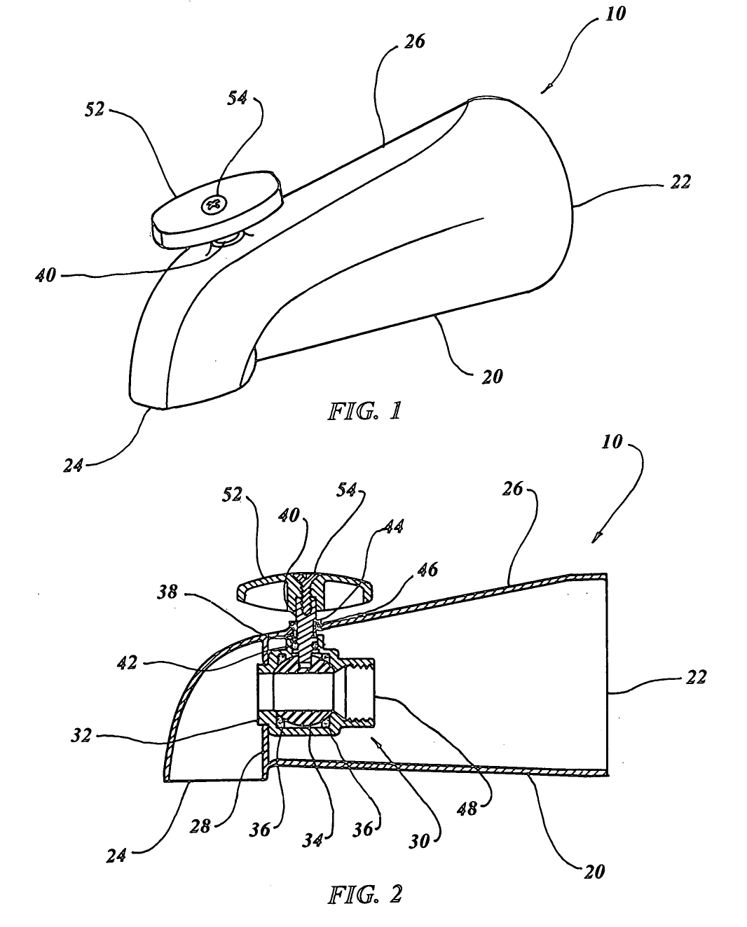

The best mode for carrying out the invention is presented in terms of a preferred embodiment. This preferred embodiment is shown in FIGS. 1 thorough 7 and is comprised of a bathtub diverter spout 10 for in-the-wall piped showers with a manual shut-off valve.

The diverter spout 10 consists of a hollow spout body 20 having a round open attaching end 22 tapering to a downward extending spout discharge opening 24 and a top surface 26 therebetween, as illustrated pictorially in FIG. 1. The actual shape may vary from the illustration and still be within the scope of the invention. The preferred material for the spout body 20 is metal or thermoplastic with brass the favored metal material and bronze, steel and aluminum being acceptable substitutes. Chrome plating is the popular finish in both the metal and thermoplastic material, with the brass optionally polished to a high shine and covered with a clear transparent coating.

A vertical bulkhead 28 is disposed within the hollow of the spout body 20, positioned adjacent to the downwardly extending spout discharge opening 24. The vertical bulkhead 28 incorporates a round hole extending therethrough. The bulkhead 28 is located aft of the downwardly extending spout, above the discharge opening 28, as illustrated in FIG. 2. The bulkhead 28 is the same material as the spout body 20 and is attached by brazing, welding, swaging or epoxy resin etc. It is also anticipated that the bulkhead may be formed as an integral part of the body 20. The vertical bulkhead 28 may be made of a material such as brass, bronze, steel, aluminum, thermoplastic etc.

A ball valve 30 is positioned extending through the round hole of the vertical bulkhead 28 and is attached in a watertight manner, as illustrated in FIG. 2. The attachment of the ball valve 30 to the round hole in the vertical bulkhead 28 is accomplished with a process such as brazing, soldering, threading, epoxy resin etc.

The ball valve 30 is preferably made with a brass body 32 and a brass ball 34. The ball 34 may have any port size however it is preferable to have the port full flow size eliminating any unnecessary pressure drop through the valve. The ball 34 is sealed between opposed pairs of ball seats 36 which are made of a resilient material, preferably poly tetra ethylene propylene (PTFE) known by its registered trademark as TEFLON®. Two thrust washers 38 are positioned in a stem 40 attached to the ball 34 with the thrust washers 38 also preferably made of poly tetra ethylene propylene (PTFE) known by its registered trademark as TEFLON®.

The stem 40 is made of brass and is sealed with an O-ring 42, preferably formed of synthetic rubber, preferably (NBR) Buna-N, with a brass packing gland 44. In order to seal the stem to the spout body 20 a stem-to-body O-ring 46 is utilized of the same synthetic rubber material as above.

The ball valve body 32 has an inlet 48 preferably sized with female threads ½ inch iron pipe size (IPS) or ¾ inch iron pipe size (IPS) for optional use with a ½ inch iron pipe size (IPS) bushing (not shown). The inlet 48 receives the in house piping nipple 50, shown in FIG. 7 in dashed lines as it is not part of the invention. The invention is for a generic, so called, front end mount for nipples extending from 4½ inches to 5.0 inches, with 4⅞ inches preferred. This length is illustrated in FIG. 7 with the alpha letter “L”.

The ball valve 30 may have any pressure rating comparable with conventional water piping however it is preferable to have a pressure range from 29 inches of mercury (inHg) to 600 pounds per square inch (PSI) in water oil and gas (WOG).

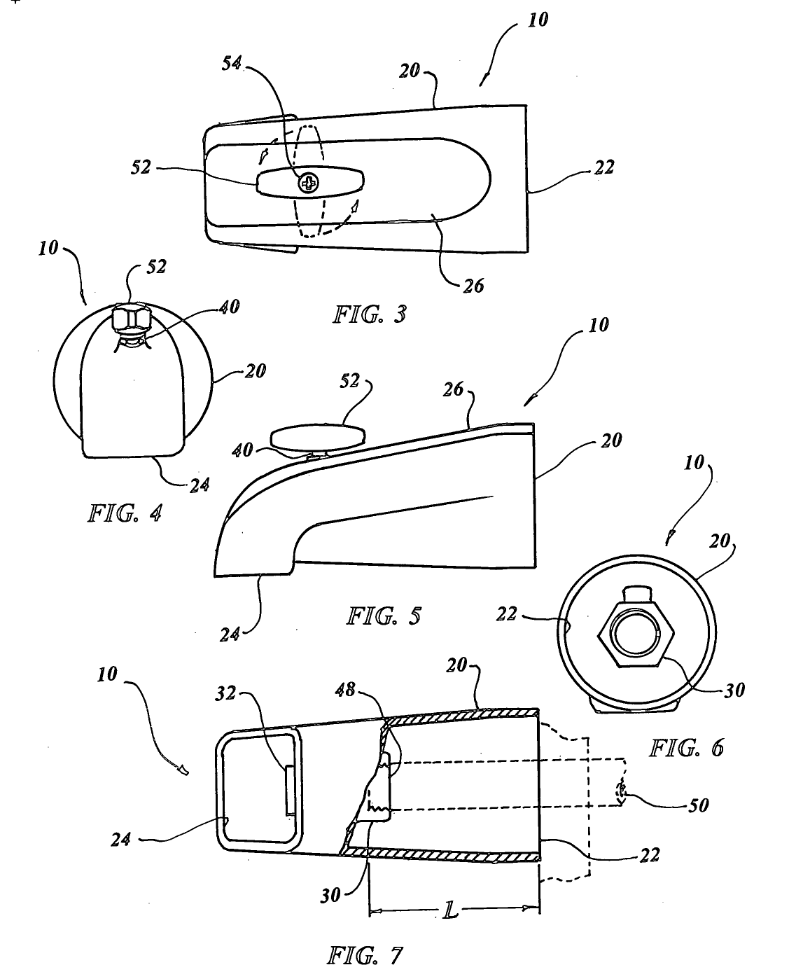

A stem handle 52 is attached to the valve stem 40 and when the ball valve 30 diverts water to the shower head the handle 52 is rotated parallel with the spout body 20, as illustrated in dashed lines in FIG. 3. When the user returns the water to the tub the handle 52 of the valve 30 is rotated to a spout transverse position, shown in solid line in FIG. 3.

The stem handle 52 is in an oval shape in the preferred embodiment however it may be in any shape, such as an outwardly extending wing shape, round rectangular flat offset shape with or without a locking position. The handle 52 is preferably attached with a threaded fastener 54 in the form of a pan head Phillips screw or the like, as depicted in FIGS. 2 and 3.

While the invention has been described in complete detail and pictorially shown in the accompanying drawings, it is not to be limited to such details, since many changes and modifications may be made to the invention without departing from the spirit and scope thereof. Hence, it is described to cover any and all modifications and forms which may come within the language and scope of the appended claims.

### BATHTUB DIVERTER SPOUT WITH BALL VALVE

### Element Designation

10 bathtub diverter spout with ball valve
20 spout body
22 round open end
24 spout discharge opening
26 top surface (of 20)
28 bulkhead
30 ball valve
32 body (of 20)
34 ball
36 ball seats
38 thrust washers
40 stem
42 stem O-ring
44 packing gland
46 stem to body O-ring
48 valve inlet
50 nipple
52 handle
54 threaded fastener

1. A bathtub diverter spout with a manual shut-off valve for in-the-wall piped showers which comprises, a hollow spout body with a ball valve disposed within the body wherein the ball valve diverts water to a shower head when the valve closed and returns water to a tub when the valve is manually opened, permitting flow to the tub for draining or subsequent filling.

2. A bathtub diverter spout with a manual shut-off valve for in-the-wall piped showers which comprises, a hollow spout body having a bulkhead therein, with a ball valve disposed through the bulkhead of the body, wherein the ball valve diverts water to a shower head when the valve is manually closed and returns water to a tub when the valve is manually opened permitting unrestricted flow to the tub for draining or subsequent filling.

3. A bathtub diverter spout with a manual shut-off valve for in-the-wall piped showers which comprises,
a hollow spout body having a round open attaching end with the body tapering to a downward extending spout having a discharge opening therein and a spout body top surface therebetween,
a vertical bulkhead having a round hole therethrough disposed within the hollow spout body, positioned adjacent to the downwardly extending spout,
a ball valve distending through the round opening of the vertical bulkhead and attached thereunto in a watertight manner,
said ball valve having an upwardly extending valve stem with the stem protruding vertically through the spout body top surface, and
a handle attached to the upwardly extending valve stem wherein the ball valve diverts water to a shower head when the ball valve is rotated parallel with the spout body and returns water flow to a bathtub when the ball valve is rotated to a spout body transverse position, permitting flow to the bathtub for draining or subsequent filling.

4. The bathtub diverter spout as recited in claim 3 wherein said spout body further comprises a material selected from the group consisting of metal and thermoplastic.

5. The bathtub diverter spout as recited in claim 4 wherein said metal is selected from the group consisting of brass, bronze, steel and aluminum.

6. The bathtub diverter spout as recited in claim 4 wherein said metal is plated with chromium.

7. The bathtub diverter spout as recited in claim 3 wherein said vertical bulkhead is attached to said spout body by a method selected from the group consisting of brazing, welding, swaging and epoxy resin.

8. The bathtub diverter spout as recited in claim 3 wherein said vertical bulkhead further comprises a material selected from the group consisting of brass, bronze, steel, aluminum and thermoplastic.

9. The bathtub diverter spout as recited in claim 3 wherein said ball valve further comprises brass body and a brass ball.

10. The bathtub diverter spout as recited in claim 3 wherein said ball valve further comprises an opposed pair of seats formed of poly tetra ethylene propylene (PTFE).

11. The bathtub diverter spout as recited in claim 3 wherein said ball valve further comprises a thrust washer formed of poly tetra ethylene propylene (PTFE) and an O-ring formed of synthetic rubber.

12. The bathtub diverter spout as recited in claim 3 wherein said ball valve further comprises a female threaded inlet having a ½ inch iron pipe size (IPS).

13. The bathtub diverter spout as recited in claim 3 wherein said ball valve further comprises a female threaded inlet having a ¾ inch iron pipe size (IPS) for optional use with a ½ inch iron pipe size (IPS) bushing.

14. The bathtub diverter spout as recited in claim 3 wherein said ball valve is attached to the round hole in said vertical bulkhead with a process selected from the group consisting of brazing, soldering, threading and epoxy resin.

15. The bathtub diverter spout as recited in claim 3 wherein said ball valve further having a full port size.

16. The bathtub diverter spout as recited in claim 3 wherein said ball valve is capable of operation within a pressure range from 29 inches of mercury (inHg) to 600 pounds per square inch (PSI) in water oil and gas (WOG).

17. The bathtub diverter spout as recited in claim 3 wherein said valve stem further having an O-ring seal made of synthetic rubber and a brass packing gland.

18. The bathtub diverter spout as recited in claim 3 wherein said ball valve having a stem handle with an oval shape.

19. The bathtub diverter spout as recited in claim 3 wherein said ball valve having a stem handle with an outwardly extending wing shape.

20. The bathtub diverter spout as recited in claim 3 wherein said ball valve having a stem handle attached to a stem with a threaded fastener.
